(19) United States
(12) Patent Application Publication
(10) Pub. No.: US 2024/0187310 A1
(43) Pub. Date: Jun. 6, 2024

(54) METHODS AND APPARATUS TO MANAGE TELEMETRY DATA IN COMPUTING SYSTEMS

(71) Applicant: Intel Corporation, Santa Clara, CA (US)

(72) Inventors: Malini K. Bhandaru, San Jose, CA (US); Ned M. Smith, Beaverton, OR (US); Sunil K. Cheruvu, Tempe, AZ (US); Anahit Tarkhanyan, Cupertino, CA (US); Mats Agerstam, Portland, OR (US)

(21) Appl. No.: 18/399,569

(22) Filed: Dec. 28, 2023

(51) Int. Cl. H04L 41/147; H04L 67/12

(52) U.S. Cl. CPC H04L 41/147; H04L 67/12

(57) ABSTRACT

Systems, apparatus, articles of manufacture, and methods are disclosed to monitor telemetry data in computing system. An example apparatus includes interface circuitry to obtain telemetry data; computer readable instructions; and programmable circuitry to instantiate: aggregation circuitry to analyze the telemetry data using an artificial intelligence model to detect an event; and action controller circuitry to: determine a telemetry collection resolution associated with the event; and instruct a telemetry collection operation associated with the telemetry data to adjust collection of the telemetry data according to the determined telemetry collection resolution.

### FIELD OF THE DISCLOSURE

This disclosure relates generally to computing systems and, more particularly, to methods and apparatus to manage telemetry data in computing systems.

### BACKGROUND

Telemetry data is information about the characteristics, operation, resource utilization, location, etc. of a computing device. Many computing devices collect and/or transmit such telemetry data to allow the computing device and/or another computing device to monitor the operation of the computing device. For example, a telemetry collection process may collect information about the operation of a processing unit (e.g., processing unit temperature, resource utilization, uptime, etc.) and such telemetry data may be continuously attested to monitor the operation of the processing unit. Attested telemetry data may be collected by a device about its own operation and/or may be collected by an external device (e.g., a sensor) connected to processing unit that collects information about the processing unit.

### BRIEF DESCRIPTION OF THE DRAWINGS

FIG. 1 is a block diagram of an example environment in which an example telemetry controller monitors telemetry data.

FIG. 2 is a block diagram of an example implementation of the telemetry controller of FIG. 1.

FIGS. 3-7 are flowcharts representative of example machine readable instructions and/or example operations that may be executed, instantiated, and/or performed by example programmable circuitry to implement the telemetry controller of FIG. 2.

FIG. 8 is an illustration of an example telemetry pipeline.

FIG. 9 illustrates an example quarantine process.

FIG. 10 illustrates several levels of network restriction.

FIG. 11 is a block diagram of an example processing platform including programmable circuitry structured to execute, instantiate, and/or perform the example machine readable instructions and/or perform the example operations of FIGS. 3-7 to implement the telemetry controller of FIG. 2.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine readable instructions of FIGS. 3-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Methods and apparatus disclosed herein monitor telemetry data from devices associated with a computing device. In some examples, the telemetry data may be analyzed to predict errors, faults, interruptions of operation, performance issues, etc. In some examples, when detecting an anomaly (e.g., an error, fault, interruption, performance issue, etc.) a change may be made to a configuration for the telemetry collection operations may be made to influence the collection (e.g., to increase a frequency of collection, a resolution of telemetry collection, etc.). In some examples, an artificial intelligence system may be trained on anomaly data to detect anomalous conditions. In some examples, based on detection of an anomaly, a quarantine response may be deployed to prevent a device experiencing anomalous condition (e.g., a security threat) from affecting other devices in a network.

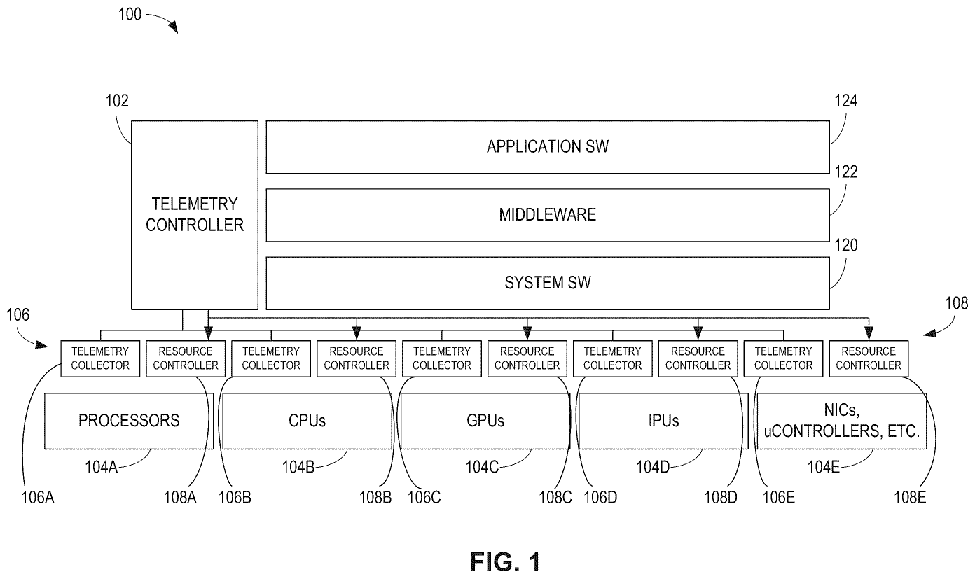

FIG. 1 is a block diagram of an example environment 100 in which an example telemetry controller 102 operates to monitor telemetry data and direct response actions based on the telemetry data. According to the illustrated example, the environment 100 is a computing device such as a personal computer, a server, a mobile computing device, a laptop, an embedded processing device, a gateway, an edge device, an internet of things (IoT) device, etc. While a single computing device (e.g., multiple components included in a case) is illustrated in FIG. 1, any number of computing devices may be linked together and one or more components (e.g., one or more telemetry controllers 102) may be shared among the computing devices (e.g., computing devices networked in a cluster, computing devices included in a rack, etc.).

The example environment 100 includes the example telemetry controller 102, example processing units 104, example telemetry collectors 106, example resource controllers 108, example system software 120, example middleware 122, and example application software 124.

The example telemetry controller 102 analyzes telemetry data collected from components (e.g., the processing units 104) of the environment 100 to detect stable and unstable conditions that may lead to security issues, resiliency issues, etc. The example telemetry controller 102 can implement various responses when such an unstable condition is predicted. For example, the telemetry controller 102 may adjust the telemetry collected (e.g., increasing a resolution and/or frequency of data collection). The telemetry controller 102 may quarantine some or all of the devices networked with the environment 100 (e.g., quarantine a portion of a network that is affected by the unstable condition). Additionally or alternatively, the telemetry controller 102 may quarantine applications. For instance, an application, as determined by its software may have a vulnerability that recently was detected or has been weaponized and may present a high risk. The telemetry controller 102 may recommend that it be patched, may, if no patch available, inactive it, or monitor it more closely to ensure that the vulnerability is not exploited.

The example telemetry controller 102 is implemented by software executing on one or more of the processing units 104. Alternatively, the telemetry controller 102 may be implemented by a hardware device such as an Application Specific Integrated Circuit (ASIC) and/or (ii) a Field Programmable Gate Array (FPGA). Alternatively, the telemetry controller 102 may be implemented by software executing on a processing unit that is external to a computing device of the environment 100.

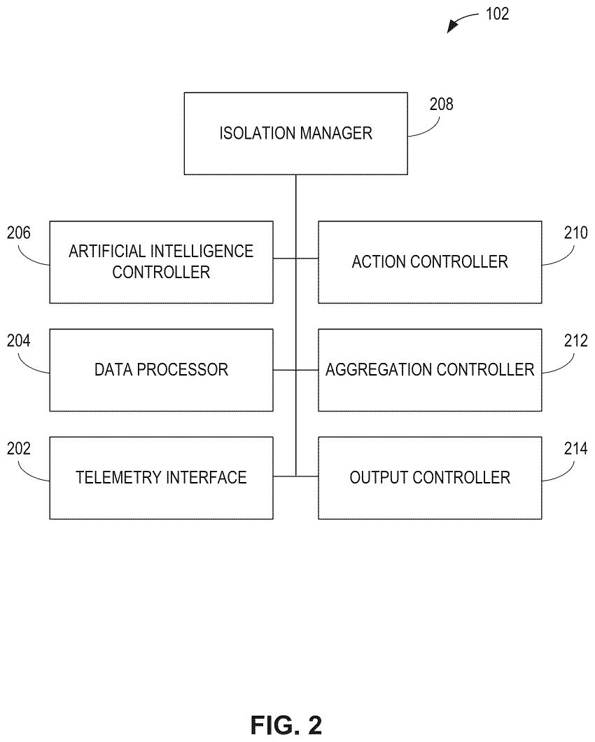

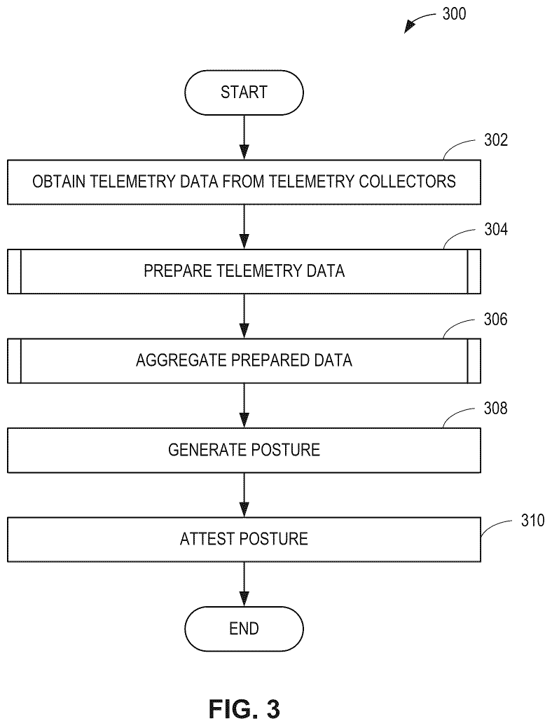

The telemetry controller 102 is described in further detail in conjunction with the block diagram of FIG. 2 and the flowcharts of FIGS. 3-7.

The processing units 104 represent various XPUs that may be included in the environment 100. An XPU refers to any type of processing unit such as central processing unit, graphics processing unit, field programmable gate array (FPGA), special purpose accelerator, etc. According to the illustrated example, the environment 100 includes an XPU 104A, a central processing unit (CPU) 104B, a graphics processing unit (GPU) 104C, an infrastructure processing unit (IPU) 104D, and a network interface controller (NIC) 104E. Alternatively, any number, type, and combination of processing units may be included in the environment 100. Furthermore, while the example environment 100 describes collection of telemetry data from processing units 100, telemetry data may be collected from any type of device within a system such as, for example, a sensor, a microcontroller, an embedded device, a controller, memory, etc. Additionally or alternatively, telemetry data may be collected from software (e.g., the example system software 120, the example middleware 122, and/or the example application software 124).

The telemetry collectors 106 (e.g., 106A, 106B 106C, 106D, and 106E) collect telemetry data (e.g., state information, measurement information, sensor results, etc.) from the processing units 104 (or other devices) and transmit the telemetry data to the telemetry controller 102. According to the illustrated example, the telemetry collectors 106 are implemented by software executing within the environment 100. Alternatively, the telemetry collectors 106 may be implemented by embedded hardware and/or a combination of hardware and software.

The resource controllers 108 (e.g., 108A, 108B, 108C, 108D, and 108E) control the operation of the telemetry collectors 106 and the computing device of the environment 100. For example, the resource controllers 108 may modify the operation of the telemetry collectors 106 (e.g., by increasing the resolution and/or collection frequency of the telemetry collectors 106 in response to the telemetry controller 102 detecting an unstable condition and decrease the resolution and/or collection frequency of the telemetry collectors 106 in response to the telemetry controller 102 detecting a stable healthy condition). The resource controllers 108 may control the operation of the processing units 104 and/or other devices. For example, the resource controllers 108 may direct quarantining of the environment 100 or other devices. For example, the resource controllers 108E may direct the network controller 104E to disconnect the environment 100 from a network to quarantine the environment 100. According to the illustrated example, the resource controllers 108 are implemented by software executing within the environment 100. Alternatively, the resource controllers 108 may be implemented by embedded hardware and/or a combination of hardware and software.

The example system software 120, middleware 122, and application software 124 represent the various software types that may be executing within the environment 100. According to the illustrated example, the software 120, 122, 124 executing within the environment is isolated from the telemetry controller 102. For example, the telemetry controller 102 may execute on the same processing unit 104 as the software 120, 122, and/or 124, but may be isolated using one or more isolation approaches. For example, the telemetry controller 102 may be implemented in a side-car environment, may be executed within a secure enclave, may be executed within a container, may be executed in an isolated process, etc.

FIG. 2 is a block diagram of an example implementation of the telemetry controller of FIG. 1 to do [Purpose of ER]. The telemetry controller of FIG. 2 may be instantiated (e.g., creating an instance of, bring into being for any length of time, materialize, implement, etc.) by programmable circuitry such as a Central Processor Unit (CPU) executing first instructions. Additionally or alternatively, the telemetry controller of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or serially on hardware. Moreover, in some examples, some or all of the circuitry of FIG. 2 may be implemented by microprocessor circuitry executing instructions and/or FPGA circuitry performing operations to implement one or more virtual machines and/or containers.

The example telemetry controller 102 of FIG. 2 includes an example telemetry interface circuitry 102, an example data processor circuitry 204, an example artificial intelligence controller circuitry 206, an example isolation manager circuitry 208, an example action controller circuitry 210, an example aggregation controller circuitry 212, and an example output controller circuitry 214.

The example telemetry interface 102 interfaces with the telemetry collectors 106 to receive telemetry data. In some examples, the telemetry interface circuitry 202 is instantiated by programmable circuitry executing telemetry interface instructions and/or configured to perform operations such as those represented by the flowchart(s) of FIG. 3-7.

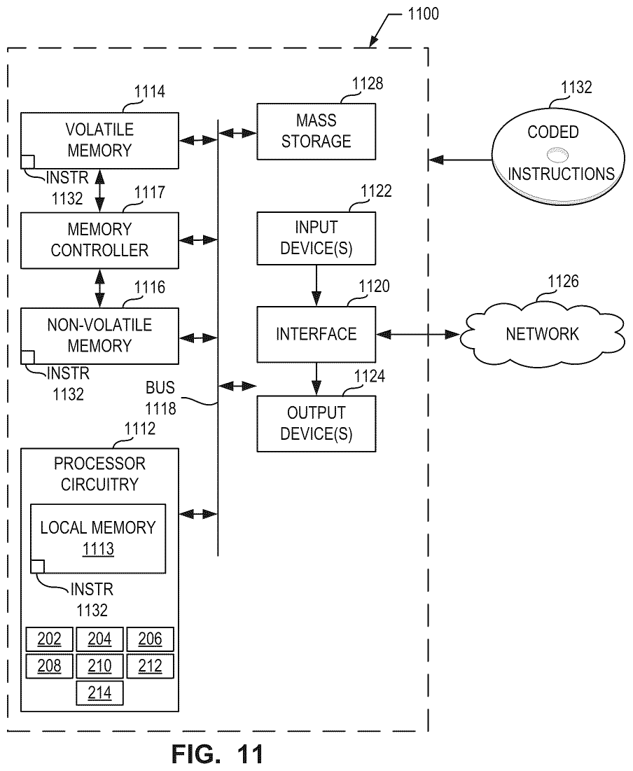

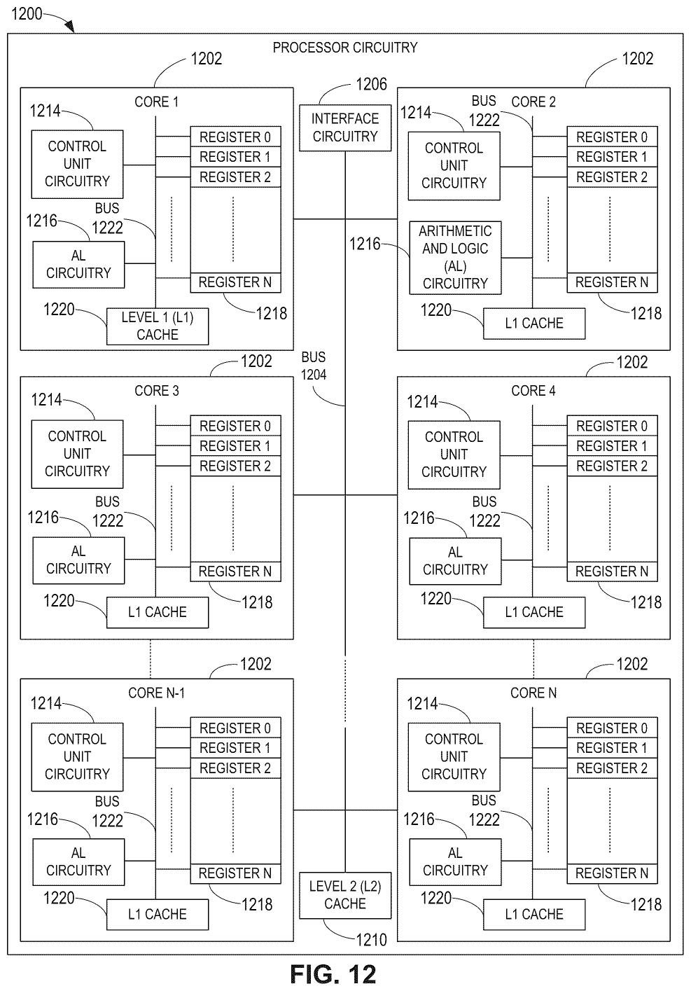

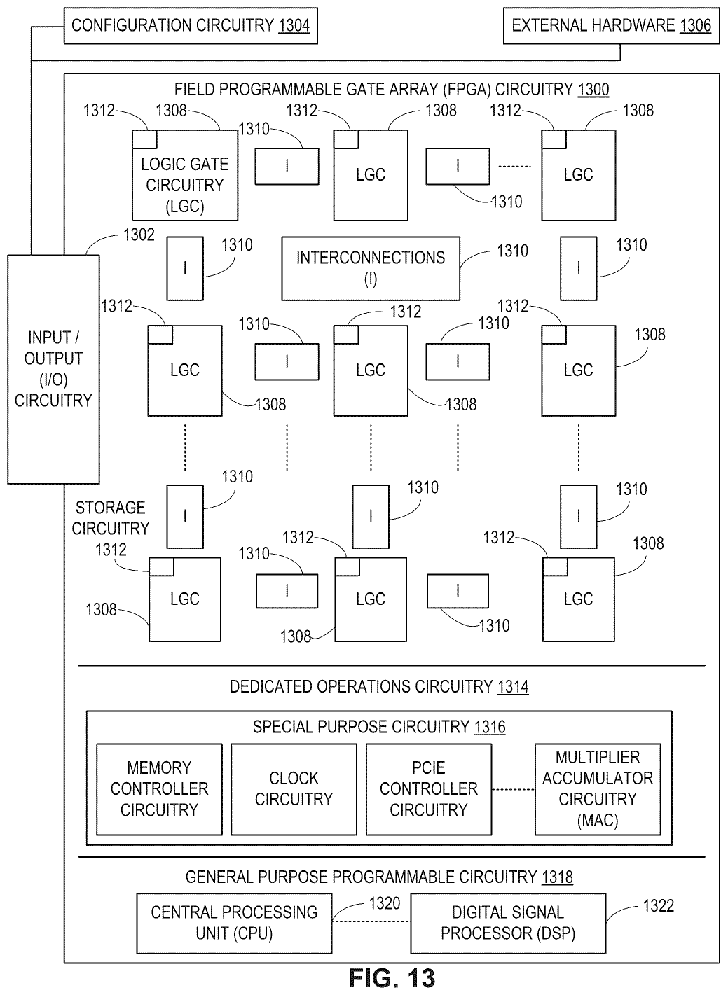

In some examples, the telemetry controller 102 includes means for interfacing with a telemetry collector. For example, the means for interface may be implemented by telemetry interface circuitry 202. In some examples, the telemetry interface circuitry 202 may be instantiated by programmable circuitry such as the example programmable circuitry 1112 of FIG. 11. For instance, the telemetry interface circuitry 202 may be instantiated by the example microprocessor 1200 of FIG. 12 executing machine executable instructions such as those implemented by at least blocks 302 of FIG. 3. In some examples, the telemetry interface circuitry 202 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the telemetry interface circuitry 202 may be instantiated by any other combination of hardware, software, and/or firmware. For example, the telemetry interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example data processor circuitry 204 receives the telemetry data from the telemetry interface circuitry 202 and processes the telemetry data to make it suitable for analysis. For example, the data processor circuitry 204 may perform data cleaning, data transformation, data filtering, data correlating, and/or data decorating.

In some examples, the data collector circuitry 204 is instantiated by programmable circuitry executing data collection instructions and/or configured to perform operations such as those represented by the flowchart(s) of FIG. 3-7.

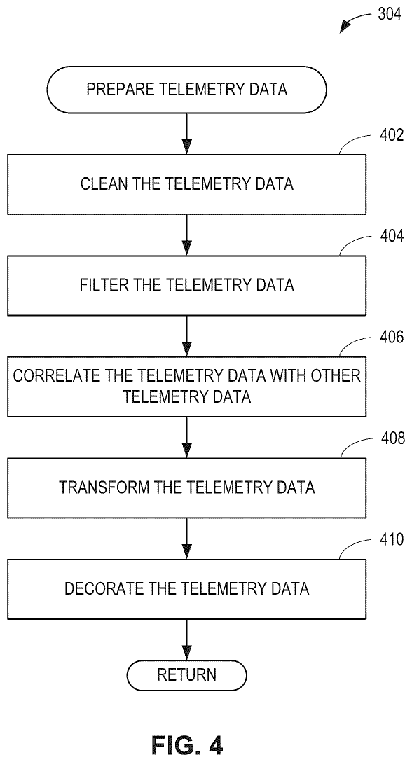

In some examples, the telemetry controller 102 includes means for collecting data. For example, the means for collecting data may be implemented by data collection circuitry 204. In some examples, the data collection circuitry 204 may be instantiated by programmable circuitry such as the example programmable circuitry 1112 of FIG. 11. For instance, the data collection circuitry 204 may be instantiated by the example microprocessor 1200 of FIG. 12 executing machine executable instructions such as those implemented by at least blocks 402-410 of FIG. 4. In some examples, the data collection circuitry 204 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the data collection circuitry 204 may be instantiated by any other combination of hardware, software, and/or firmware. For example, the data collection circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The artificial intelligence controller circuitry 206 utilizes models trained on sample anomaly data to perform artificial intelligence analysis of telemetry data processed by the data processor circuitry 204 to detect anomalous conditions. The artificial intelligence controller circuitry 206 maintains inference and model data that analyses telemetry data to detect early warning signatures signaling security and resiliency conditions that may affect a workload of the environment 100.

In some examples, the artificial intelligence controller circuitry 206 is instantiated by programmable circuitry executing data collection instructions and/or configured to perform operations such as those represented by the flowchart(s) of FIG. 3-7.

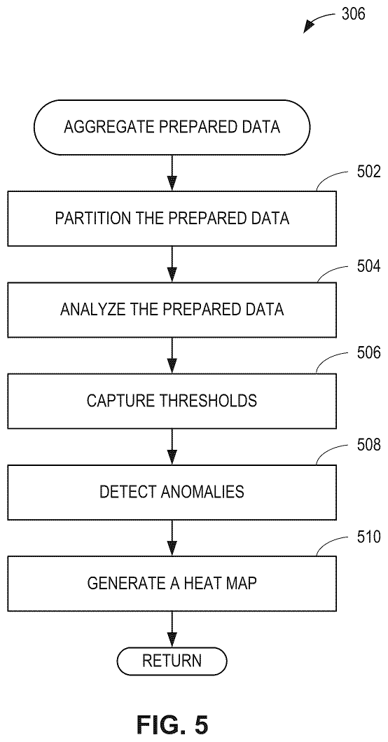

In some examples, the telemetry controller 102 includes means for analyzing data using artificial intelligence. For example, the means for analyzing may be implemented by artificial intelligence controller circuitry 206. In some examples, the artificial intelligence controller circuitry 206 may be instantiated by programmable circuitry such as the example programmable circuitry 1112 of FIG. 11. For instance, the artificial intelligence controller circuitry 206 may be instantiated by the example microprocessor 1200 of FIG. 12 executing machine executable instructions such as those implemented by at least blocks 504-508 of FIG. 5. In some examples, the artificial intelligence controller circuitry 206 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the artificial intelligence controller circuitry 206 may be instantiated by any other combination of hardware, software, and/or firmware. For example, the artificial intelligence controller circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The isolation manager circuitry 208 manages the isolation of the operations of the telemetry controller 102 from the other software and components of the environment 100. For example, the isolation manager circuitry 208 may implement a side-car environment in which the components of the telemetry controller 102 may operate in isolation from the other software 120, 122, 124 of the environment 100. Alternatively, any other type of isolation (e.g., enclave, container, etc.) may be utilized. The example isolation manager may include initialization code/instructions, bootstrap code/instructions, and/or a root of trust to securely boot the telemetry controller 102. The telemetry interface 202 may interface to other components of the telemetry controller 102 that are initialized by the isolation manager circuitry 216. The isolation manager circuitry 216 and the telemetry interface 202 may attest the various other components of the telemetry controller 102 as part of a bootstrap sequence or as part of a “bring up” routine supported by, for example, microcode/Xcode.

In some examples, the isolation manager circuitry 208 is instantiated by programmable circuitry executing data collection instructions and/or configured to perform operations such as those represented by the flowchart(s) of FIG. 3-7.

In some examples, the telemetry controller 102 includes means for managing isolation. For example, the means for managing isolation may be implemented by isolation manager circuitry 208. In some examples, the isolation manager circuitry 208 may be instantiated by programmable circuitry such as the example programmable circuitry 1112 of FIG. 11. For instance, the isolation manager circuitry 208 may be instantiated by the example microprocessor 1200 of FIG. 12 executing machine executable instructions. In some examples, the isolation manager circuitry 208 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the isolation manager circuitry 208 may be instantiated by any other combination of hardware, software, and/or firmware. For example, the isolation manager circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The action controller circuitry 210 directs actions resulting from the analysis conducted by the telemetry controller 102. For example, the action controller circuitry 210 may direct a change in the telemetry collection such as an increase or decrease in collection resolution, an increase or decrease in collection frequency, an isolation of one or more device (e.g., the computing device of the environment 100), etc.

In some examples, the action controller circuitry 210 is instantiated by programmable circuitry executing data collection instructions and/or configured to perform operations such as those represented by the flowchart(s) of FIG. 3-7.

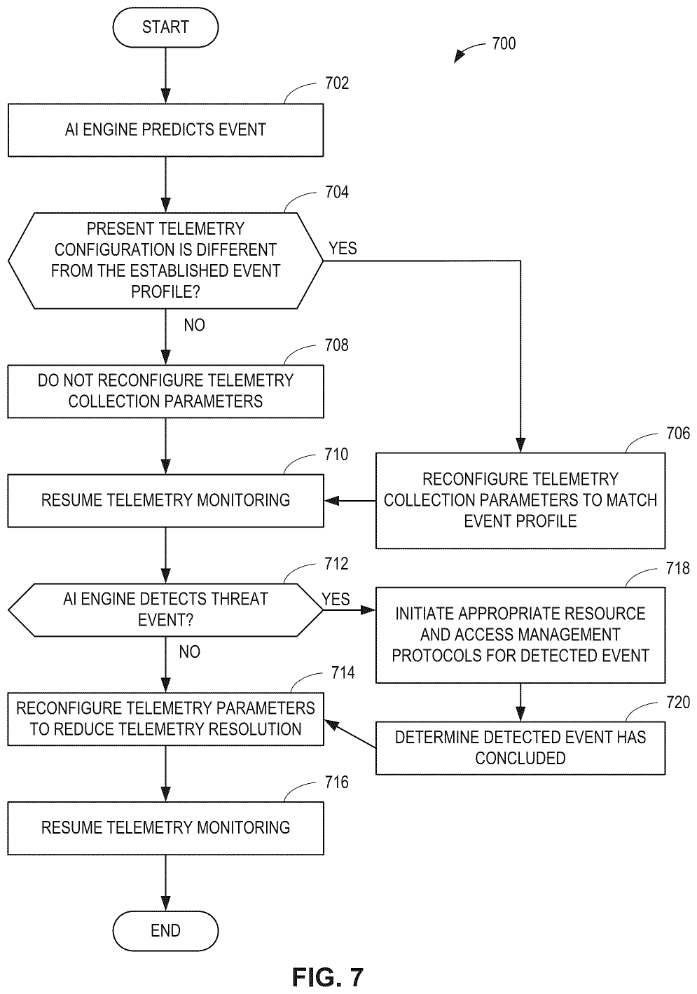

In some examples, the telemetry controller 102 includes means for controlling an action. For example, the means for controlling may be implemented by action controller circuitry 210. In some examples, the action controller circuitry 210 may be instantiated by programmable circuitry such as the example programmable circuitry 1112 of FIG. 11. For instance, the action controller circuitry 210 may be instantiated by the example microprocessor 1200 of FIG. 12 executing machine executable instructions such as those implemented by at least blocks 706 and 714 of FIG. 7. In some examples, the action controller circuitry 210 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the action controller circuitry 210 may be instantiated by any other combination of hardware, software, and/or firmware. For example, the action controller circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The aggregation controller circuitry 212 partitions and analyzes the telemetry data to capture threshold (e.g., minimum and maximum thresholds), timeseries sequences, statistically relevant conditions, perform pattern recognition, anomaly detection, and/or to apply the artificial intelligence modeling training for the artificial intelligence controller circuitry 206. The aggregation controller circuitry 212 may generates heat maps that correlate resource impact with telemetry activity and determine that resources with high utilization may be an indication of a denial-of-service attack, a failure-restart activity, and/or broken load balancing optimization.

In some examples, the aggregation controller circuitry 212 is instantiated by programmable circuitry executing data collection instructions and/or configured to perform operations such as those represented by the flowchart(s) of FIG. 3-7.

In some examples, the telemetry controller 102 includes means for aggregating. For example, the means for aggregating may be implemented by aggregation controller circuitry 212. In some examples, the aggregation controller circuitry 212 may be instantiated by programmable circuitry such as the example programmable circuitry 1112 of FIG. 11. For instance, the aggregation controller circuitry 212 may be instantiated by the example microprocessor 1200 of FIG. 12 executing machine executable instructions such as those implemented by at least blocks 306 of FIG. 3 and 502-510 of FIG. 5. In some examples, the aggregation controller circuitry 212 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the aggregation controller circuitry 212 may be instantiated by any other combination of hardware, software, and/or firmware. For example, the aggregation controller circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The output controller circuitry 214 interfaces the telemetry controller 102 with the resource controllers 108 to transmit resource control instructions.

In some examples, the output controller circuitry 214 is instantiated by programmable circuitry executing data collection instructions and/or configured to perform operations such as those represented by the flowchart(s) of FIG. 3-7.

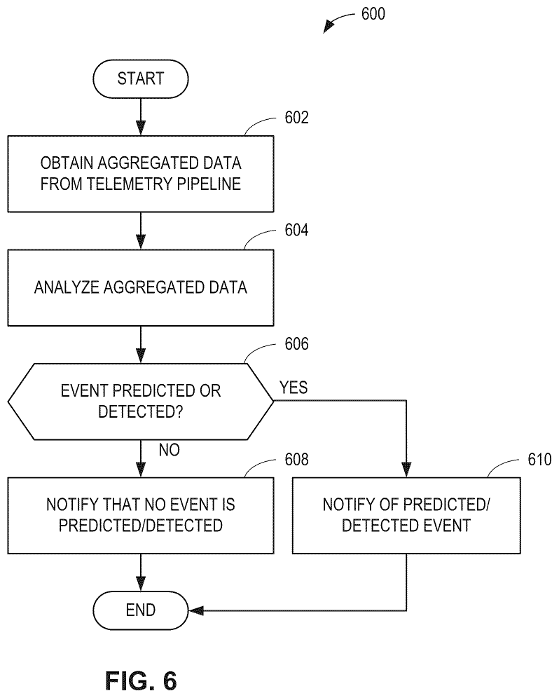

In some examples, the telemetry controller 102 includes means for output. For example, the means for output may be implemented by output controller circuitry 214. In some examples, the output controller circuitry 214 may be instantiated by programmable circuitry such as the example programmable circuitry 1112 of FIG. 11. For instance, the output controller circuitry 214 may be instantiated by the example microprocessor 1200 of FIG. 12 executing machine executable instructions such as those implemented by at least blocks 608-610 of FIG. 6. In some examples, the output controller circuitry 214 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the output controller circuitry 214 may be instantiated by any other combination of hardware, software, and/or firmware. For example, the output controller circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In operation of the telemetry controller 102, the isolation manager circuitry 208 facilitates an isolated environment (e.g., isolated from other software of the environment 100) for the operation of the components of the telemetry controller 102. Telemetry data from the processing units 104 is received by the telemetry interface circuitry 202 and provided to the data processor circuitry 204 and performs processing of the telemetry data to prepare the data for analysis. The aggregation controller circuitry 212 partitions and analyzes the data to capture min/max thresholds, time series sequences, statistically relevant conditions, perform pattern recognition, anomaly detection, and to apply AI model training and/or inference. The aggregation controller circuitry 212 may generate a heat map that correlates resource impact with telemetry activity. “Hot” resources can be an indication of a denial-of-service attack, failure-restart activity, or broken load balancing optimization. The artificial intelligence controller circuitry 206 utilizes one or more trained AI models to analyze the telemetry data to predict intrusion, anomalous conditions, resource mis-utilization, train AI models, etc. The detection may provide an early warning, predict a future condition or may provide an indication of an ongoing issue. The action controller circuitry 210 directs actions via the output controller circuitry 214 in response to detected conditions. For example, the action controller circuitry 210 may dynamically adjust current telemetry collection profiles to increase resolution toward suspected security/resiliency events such that an increased resolution may reduce false positive/negative rates leading to improved final detection of such events. Upon detection of security/resiliency events, the action controller circuitry 210 may direct the resource controllers 108 to quarantine one or more devices to provide protection from security/resiliency side effects of one device that may affect other devices. For example, a buffer exploit in the application software 124 may be controlled by isolating various system resources via resource controllers 108 (e.g., with cooperation from system software 120 and isolated execution capabilities). In another example, a denial of service (DOS) attack may be thwarted by responding with firewall rules to drop packets from a particular source or, if a distributed DOS attack, firewall rules to drop a large percentage of packets to the destination while the DOS attack is occurring.

While an example manner of implementing the telemetry controller of FIG. 1 is illustrated in FIG. 2, one or more of the elements, processes, and/or devices illustrated in FIG. 2 may be combined, divided, re-arranged, omitted, eliminated, and/or implemented in any other way. Further, the example telemetry interface circuitry 202, the example data processor circuitry 204, the example artificial intelligence controller circuitry 206, the example isolation manager circuitry 208, the example action controller circuitry 210, the example aggregation controller circuitry 212, the example output controller circuitry 214, and/or, more generally, the example telemetry controller of FIG. 2, may be implemented by hardware alone or by hardware in combination with software and/or firmware. Thus, for example, any of the example telemetry interface circuitry 202, the example data processor circuitry 204, the example artificial intelligence controller circuitry 206, the example isolation manager circuitry 208, the example action controller circuitry 210, the example aggregation controller circuitry 212, the example output controller circuitry 214, and/or, more generally, the example telemetry controller, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example telemetry controller of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the telemetry controller of FIG. 2 and/or representative of example operations which may be performed by programmable circuitry to implement and/or instantiate the telemetry controller of FIG. 2, are shown in FIGS. 3-7. The machine readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-7, many other methods of implementing the example telemetry controller may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to analyze telemetry data. The example machine-readable instructions and/or the example operations 300 of FIG. 3 begin at block 302, at which the example telemetry interface circuitry 202 obtains telemetry data (e.g., from the telemetry collectors 106 of FIG. 1). The example data processor circuitry 204 prepares the telemetry data for analysis (block 304). The example aggregation controller circuitry 212 and the example artificial intelligence controller circuitry 206 aggregates the prepared data to analyze the data for anomalies, security issues, resiliency issues, etc. (block 306). The example action controller circuitry 210 generates a posture (e.g., an output indicating detected conditions) (block 308). For example, the posture may be in a format that is suitable for workload-specific consumption such as posture databases, data lakes, artificial intelligence models (e.g., that can be distributed to processors enhanced with artificial intelligence hosting capabilities), posture streaming, and alerting. The example output controller circuitry 214 attests the posture (block 310). For example, the attestation may protect the posture using a cryptographic key (e.g., a Device Identifier Composition Engine (DICE) that binds the posture signing key to the telemetry collection subsystem (e.g., the telemetry controller 102, the telemetry collectors 106, and the resource controllers 108).

The use of attestation may allow a recipient of the posture to verify the integrity of the posture based on trust in the signing key and in the telemetry collection subsystem.

Additionally, given an AI model trained within the artificial intelligence controller circuitry 206, the attestation context, such as a DICE TCB Component Identifier (TCI) may be incorporated into training data such that the trained model is aware of the environment in which the training occurred. Furthermore, inference using the artificial intelligence controller circuitry 206 may include an attestation context (as described above) to reference, report, or otherwise incorporate the attestation context such that the inference behavior is aware of the attestation context.

In some examples, additional operations may be performed such as, for example, feature extraction, normalization, sampling control, extrapolation, interpolation, bucketing, and other operations to support distributed data integration.

FIG. 4 is a flowchart representative of example machine readable instructions and/or example operations that may be executed, instantiated, and/or performed by programmable circuitry to implement block 304 of FIG. 3. The example machine-readable instructions and/or the example operations 304 of FIG. 4 begin at block 402, at which the example data processor circuitry 204 cleans the telemetry data (e.g., removes noisy data, discretizes the data, removes extraneous information, etc.). The example data processor circuitry 204 then filters the telemetry data (block 404). For example, the data processor circuitry 204 may filter out telemetry data that is invalid, incomplete, or otherwise known to not properly indicate the condition of the monitored devices.

The example data processor circuitry 204 then correlates the telemetry data with other received telemetry data (block 406). For example, the data processor circuitry 204 may determine relationships among telemetry data from multiple devices (e.g., correlated in time, correlated based on other conditions such as processing similar data or inputs, etc.). The example data processor circuitry 204 transforms the telemetry data to enable processing of the data (block 408). For example, the data processor circuitry 204 may form the telemetry data into data sets, may enhance metadata of the telemetry data, etc. The data processor circuitry 204 decorates the telemetry data to add additional information (block 410). For example, the data processor circuitry 204 may add context information that may be inferred from the data such as location data, timestamps, context information available (e.g., information from other sensors), etc.

FIG. 5 is a flowchart representative of example machine readable instructions and/or example operations that may be executed, instantiated, and/or performed by programmable circuitry to implement block 306 of FIG. 3. The example machine-readable instructions and/or the example operations 306 of FIG. 5 begin at block 502, at which the example aggregation controller circuitry 212 partitions the telemetry data. The example aggregation controller circuitry 212 analyzes the prepared data (e.g., by applying models of the artificial intelligence controller circuitry 206) (block 504). The example aggregation controller circuitry 212 captures thresholds indicated in the data (e.g., based on ranges of the data) (block 506). The example aggregation controller circuitry 212 detects anomalies indicated by the data (block 508). The example aggregation controller circuitry 212 also generates a heat map that correlates resource impact with telemetry activity (block 510).

FIG. 6 is a flowchart representative of example machine readable instructions and/or example operations 600 that may be executed, instantiated, and/or performed by programmable circuitry to analyze telemetry data. The example machine-readable instructions and/or the example operations 600 of FIG. 6 begin at block 602, at which the example artificial intelligence controller circuitry 206 obtains aggregated data from the telemetry pipeline (block 602). The example artificial intelligence controller circuitry 206 analyzes the aggregated data by applying trained artificial intelligence models (e.g., models trained to detect anomalous conditions) (block 604). The example action controller circuitry 210 determines if an event was predicted or detected by the example artificial intelligence controller circuitry 206 (block 606). When an event is not detected, the example action controller circuitry 210 outputs an indication, via the output controller circuitry 214, that no event was detected (block 608). For example, no action may be taken or telemetry. When an event is detected, the example action controller circuitry 210 outputs an indication that the predicted/detected event was identified (block 610). For example, the action controller circuitry 210 may notify the resource controllers 108 to perform an isolation/quarantine of one or more components of the environment 100.

FIG. 7 is a flowchart representative of example machine readable instructions and/or example operations 700 that may be executed, instantiated, and/or performed by programmable circuitry to analyze telemetry data. The example machine-readable instructions and/or the example operations 700 of FIG. 7 begin at block 702, at which the artificial intelligence controller circuitry 206 predicts or detects an event (block 702). The example action controller circuitry 210 determines if a current telemetry configuration is different from an established event profile (block 704). For example, the action controller circuitry 210 may store a preferred telemetry configuration associated with each type of event. When the current telemetry configuration is different, the example action controller circuitry 210 reconfigures the telemetry collection parameters to match the established event profile (e.g., by directing the telemetry collectors 106 and/or the resource controllers 108) (block 706). When the current telemetry configuration matches a telemetry configuration associated with the event, the action controller circuitry 210 does not reconfigure the telemetry collection parameters (block 708).

After the telemetry collection parameters are configured (after block 706 or block 710), the action controller circuitry 210 directs, via the output controller circuitry 214, the resumption of telemetry monitoring and/or collection (block 710). The artificial intelligence controller circuitry 206 determines if an event is detected (block 712). When no event is detected (e.g., the event detected in block 702 has resolved, ended, etc.), the example action controller circuitry 210 reconfigures the telemetry collection parameters (block 714). For example, the action controller circuitry 210 may direct a reduction in telemetry resolution to reduce the resource utilization associated with telemetry collection (e.g., if telemetry collection resolution was increased when an event was detected). The example action controller circuitry 210 instructions telemetry monitoring to resume (block 716) and the process of FIG. 7 end (e.g., until a new event is detected).

Returning to block 712, when a threat event is detected, the action controller circuitry 210 initiates appropriate resource and access management protocols for the detected event (block 718). For example, the action controller circuitry 210 may direct an increase in telemetry resolution, an isolation of a device or component, etc. The artificial intelligence controller circuitry 206 determines that the event has concluded (block 720) and control returns to block 714 to adjust the telemetry collection parameters.

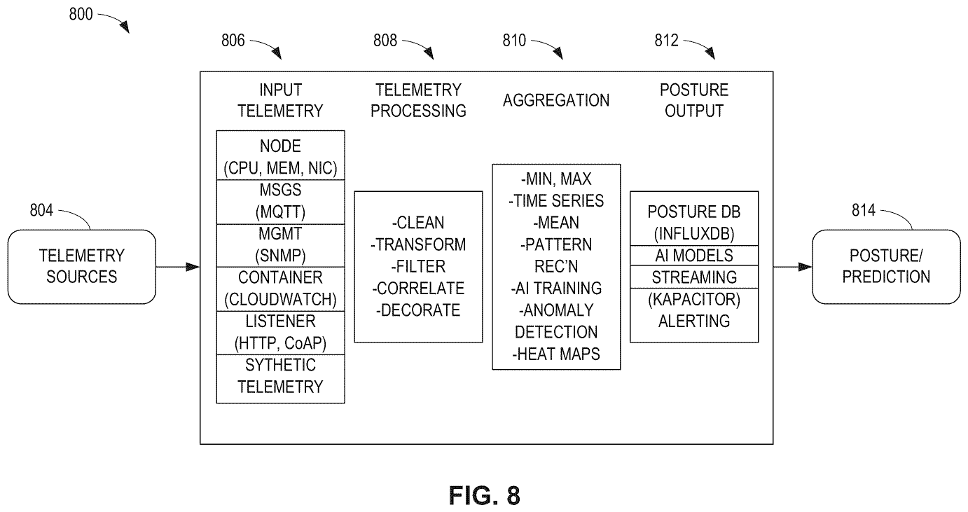

FIG. 8 is an illustration of an example telemetry pipeline 800 that may be employed by the telemetry controller 102. According to the example, telemetry data is received from one or more telemetry sources 804 and may be in any type of input format 806. The example telemetry controller 102 performs telemetry processing 808 and aggregation 810 and then forms an output posture 812 that is output 814. The telemetry pipeline 800 can be used to simulate attack/failure scenarios where synthetic telemetry scenarios can be planned and fed into the telemetry pipeline 800 to observe and tweak expected posture output.

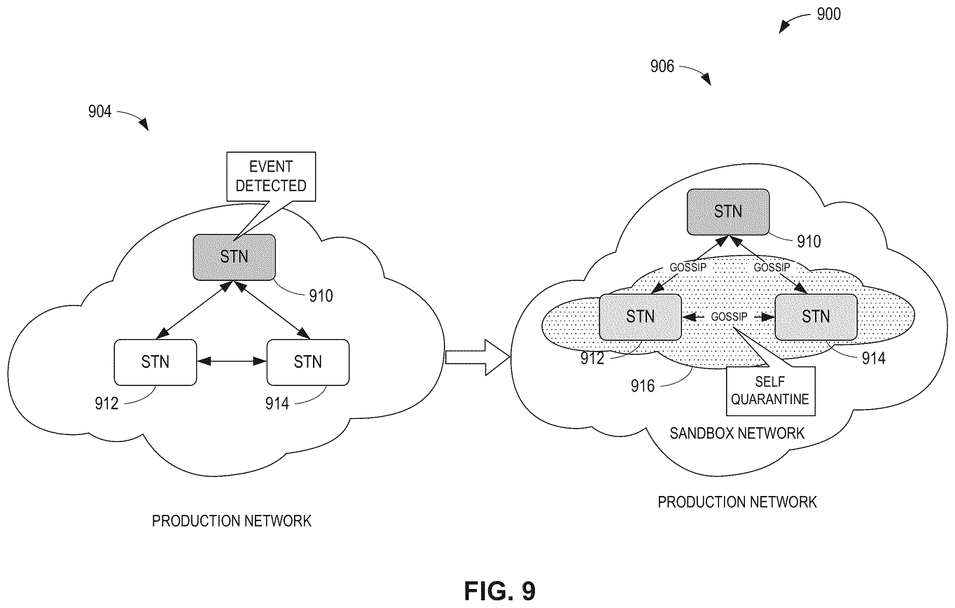

FIG. 9 illustrates an example quarantine process 900. At a first stage 904, three smart telemetry nodes (STN) 910, 912, 914 are in communication. At the first stage STN 910 detects an event. At a second stage, STN 910 communicates information about the detected event to the other STNs 912, 914. For example, the STNs 910, 912, and 914 may communicate information amongst each other using a communication protocol such as the GOSSIP protocol. The example STNs 912 and 914 determine to self-quarantine themselves away from the STN 910 to prevent the anomalous condition of the STN 910 from affecting the STNs 912 and 914. Accordingly, the STNs 912 and 914 form a sandbox network that does not include the STN 910. Neighboring smart telemetry nodes may therefore double as smart access management nodes that respond to dynamic conditions with automated mitigation or recovery. A neighboring node may receive early warning of a critical pending events that triggers adjustments to quality of service, availability, security, or other profiles to optimize not only the particular node, but also clusters of nodes for a best possible security and resiliency counter measures. Artificial intelligence capabilities in the STN(s) ensures the automated detection and response are appropriate for the given workload/application (e.g., the responses may be based on importance and risk averseness). For example, a security company's website, databases of a finance entity, and resources of a healthcare environment may be associated with more stringent responses than a user's gaming device.

STNs in the example network 904 may be configured as a pipeline of STNs wherein each stage of the pipeline supplies input telemetry source(s) 804 for a stage N STN from a stage N−1 STN output 814 such that an N-stage pipeline may be constructed forming a distributed neural network for telemetry streams. For example, the telemetry sources 804 for the STN 910 may be supplied by the output 814 of the STN 912.

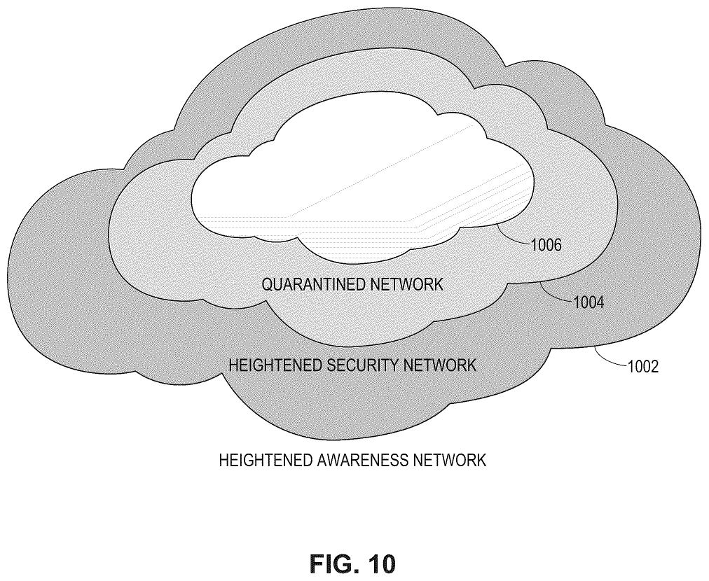

FIG. 10 illustrates several levels of network restriction that may be utilized to quarantine devices based on a detected event. Different levels of quarantine may be associated with different event types and associated threat levels. According to the illustrated example, a heightened awareness network 1002 may provide a first level of restriction, a heightened security network 1004 may provide a second, more restricted, level of restriction, and a quarantined network 1006 may provide a third, most restricted level of restriction. Policies may be used to define a variety of responses to detected events. For example, a policy may distribute data into data lakes that optimize for compute intensive applications. Alerts may signal loss (or potential loss) of connectivity resulting in the formation of node clusters that apply an operational posture suited to current threat levels, such as the formation of a heightened awareness network, that may progress to a heightened security network if detected threats escalate, which may further escalate to a fully quarantined network.

FIG. 11 is a block diagram of an example programmable circuitry platform 1100 structured to execute and/or instantiate the example machine-readable instructions and/or the example operations of FIGS. 3-7 to implement the telemetry controller of FIG. 2. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the example telemetry interface circuitry 202, the example data processor circuitry 204 the example artificial intelligence controller circuitry 206, the example isolation manager circuitry 208, the example action controller circuitry 210, the example aggregation controller circuitry 212, and the example output controller circuitry 214.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU. The output devices 1124 may additionally be implemented by output operations such as firewall rules, application deployments in a cloud environment, telemetry and resource output operations, etc.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIGS. 3-7, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 3-7 to effectively instantiate the circuitry of FIG. 2 as logic circuits to perform operations corresponding to those machine readable instructions. In some such examples, the circuitry of FIG. 2 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 3-7.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowchart(s) of FIGS. 3-7 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-7. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-7. As such, the FPGA circuitry 1300 may be configured and/or structured to effectively instantiate some or all of the operations/functions corresponding to the machine readable instructions of the flowchart(s) of FIGS. 3-7 as dedicated logic circuits to perform the operations/functions corresponding to those software instructions in a dedicated manner analogous to an ASIC. Therefore, the FPGA circuitry 1300 may perform the operations/functions corresponding to the some or all of the machine readable instructions of FIGS. 3-7 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine readable instructions of FIGS. 3-7 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowchart(s) of FIGS. 3-7 to perform first operation(s)/function(s), the FPGA circuitry 1300 of FIG. 13 may be configured and/or structured to perform second operation(s)/function(s) corresponding to a second portion of the machine readable instructions represented by the flowcharts of FIGS. 3-7, and/or an ASIC may be configured and/or structured to perform third operation(s)/function(s) corresponding to a third portion of the machine readable instructions represented by the flowcharts of FIGS. 3-7.

It should be understood that some or all of the circuitry of FIG. 2 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 2 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

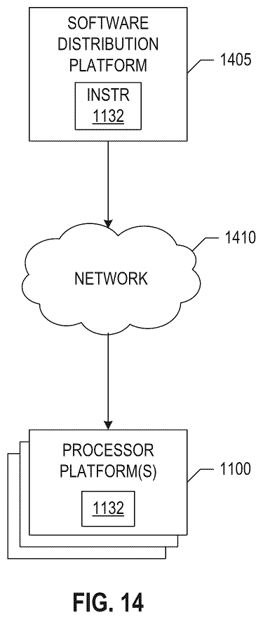

A block diagram illustrating an example software distribution platform 1405 to distribute software such as the example machine readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions of FIGS. 3-7, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions of FIGS. 3-7, may be downloaded to the example programmable circuitry platform 1100, which is to execute the machine readable instructions 1132 to implement the telemetry controller. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to monitor telemetry data in computing systems, the apparatus comprising:
interface circuitry to obtain telemetry data;
computer readable instructions; and
programmable circuitry to instantiate:
aggregation circuitry to analyze the telemetry data using an artificial intelligence model to detect an event; and
action controller circuitry to:
determine a telemetry collection resolution associated with the event; and
instruct a telemetry collection operation associated with the telemetry data to adjust collection of the telemetry data according to the determined telemetry collection resolution.

2. The apparatus of claim 1, wherein the programmable circuitry includes one or more of:
at least one of a central processor unit, a graphics processor unit, or a digital signal processor, the at least one of the central processor unit, the graphics processor unit, or the digital signal processor having control circuitry to control data movement within the programmable circuitry, arithmetic and logic circuitry to perform one or more first operations corresponding to machine-readable data, and one or more registers to store a result of the one or more first operations, the machine-readable data in the apparatus;
a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or
Application Specific Integrated Circuitry (ASIC) including logic gate circuitry to perform one or more third operations.

3. The apparatus of claim 1, wherein the telemetry data is associated with a processing unit.

4. The apparatus of claim 1, wherein the action controller circuitry is further to instruct at least one of a computing device or an application to be quarantined within a network based on the event.

5. The apparatus of claim 1, wherein the action controller circuitry is further to instruct a processing unit to be quarantined from other components of a computing system based on the event.

6. The apparatus of claim 1, wherein the event is a prediction of a future anomalous condition.

7. The apparatus of claim 1, wherein the event is a detection of an active anomalous condition.

8. The apparatus of claim 1, wherein the apparatus is a first node and the interface circuitry is to receive at least some of the telemetry data from a second node that has analyzed the telemetry data using an artificial intelligence model.

9. A non-transitory computer-readable medium comprising instructions that, when executed, cause a machine to at least:
analyze telemetry data using an artificial intelligence model to detect an event;
determine a telemetry collection resolution associated with the event; and
instruct a telemetry collection operation associated with the telemetry data to adjust collection of the telemetry data according to the determined telemetry collection resolution.

10. The non-transitory computer-readable medium of claim 9, wherein the telemetry data is associated with a processing unit.

11. The non-transitory computer-readable medium of claim 9, wherein the instructions, when executed, cause the machine to instruct at least one of a computing device or an application to be quarantined within a network based on the event.

12. The non-transitory computer-readable medium of claim 9, wherein the instructions, when executed, cause the machine to instruct a processing unit to be quarantined from other components of a computing system based on the event.

13. The non-transitory computer-readable medium of claim 9, wherein the event is a prediction of a future anomalous condition.

14. The non-transitory computer-readable medium of claim 9, wherein the event is a detection of an active anomalous condition.

15. The non-transitory computer-readable medium of claim 9, wherein the machine is a first node and at least some of the telemetry data is obtained from a second node that has analyzed the telemetry data using an artificial intelligence model.

16. A method to manage telemetry data, the method comprising:
analyzing telemetry data using an artificial intelligence model to detect an event;
determining a telemetry collection resolution associated with the event; and
instructing a telemetry collection operation associated with the telemetry data to adjust collection of the telemetry data according to the determined telemetry collection resolution.

17. The method of claim 16, wherein the telemetry data is associated with a processing unit.

18. The method of claim 16, further comprising instructing at least one of a computing device or an application to be quarantined within a network based on the event.

19. The method of claim 16, further comprising instructing a processing unit to be quarantined from other components of a computing system based on the event.

20. The method of claim 16, wherein the event is a prediction of a future anomalous condition.
